(19) United States
(12) Patent Application Publication
(10) Pub. No.: US 2011/0071177 A1
(43) Pub. Date: Mar. 24, 2011

(54) FUNGICIDAL ACTIVE SUBSTANCE COMBINATION

(75) Inventors: Isolde HÄEUSER-HAHN, Leverkusen (DE); Peter Dahmen, Neuss (DE); Ulrike Wachendorff-Neumann, Neuwied (DE); Albert Witzenberger, Burscheid (DE)

(73) Assignee: Bayer CropScience AG, Monheim (DE)

(21) Appl. No.: 12/953,070

(22) Filed: Nov. 23, 2010

Related U.S. Application Data
(62) Division of application No. 12/096,287, filed on Aug. 18, 2008.

(30) Foreign Application Priority Data
Dec. 9, 2005 (DE) 10 2005 058 838.7
Nov. 27, 2006 (EP) PCT/EP2006/011334

(51) Int. Cl. A01N 43/54; A01P 3/00

(52) U.S. Cl. 514/275

(57) ABSTRACT

Methods of controlling fungi with an active compound combination that includes trifloxystrobin and pyrimethanil.

This application is a divisional of U.S. application Ser. No. 12/096,287, filed Aug. 18, 2008; which is a National Stage Application of PCT/EP2006/011334, filed Nov. 27, 2006, which claims priority to DE 10 2005 058 838.7, filed Dec. 9, 2005, the disclosures of which are herein incorporated by reference in their entireties.

### BACKGROUND OF THE INVENTION

1. Field of the Invention

The present invention relates to a novel active compound combination which comprises a known oxime ether derivative and a known anilinopyrimidine and which is highly suitable for controlling phytopathogenic fungi.

2. Description of Related Art

It is already known that the oxime derivative 2-[α-{[(α-methyl-3-trifluoromethylbenzyl)imino]oxy}-o-tolyl]glyoxylic acid methyl ester O-methyloxime with the common name trifloxystrobin has fungicidal properties (cf. EP-A-0 460 575). The activity of this compound is good; however, it is sometimes unsatisfactory at low application rates. The preparation of this compound is likewise known from EP-A-0 460 575.

Moreover, it is known that the anilinopyrimidine 4,6-dimethyl-N-phenyl-2-pyrimidinamine with the common name pyrimethanil has fungicidal properties (cf. DD 00151404). The activity of this compound is good; however, it is sometimes unsatisfactory at low application rates. The preparation of this compound is likewise known.

Moreover, it is known that trifloxystrobin can generally be combined with various fungicides (for example WO 97/00012, WO 97/00013). In a relatively long list, one of the possible mixing partners mentioned is inter alia pyrimethanil (Research Disclosure 41512 1998, pp. 1437-1439).

Since the environmental and economic requirements imposed on modern-day fungicides are continually increasing, with regard, for example, to the spectrum of action, toxicity, selectivity, application rate, formation of residues, and favourable preparability, and since, furthermore, there may be problems, for example, with resistances, a constant task is to develop new fungicides which in some areas at least have advantages over their known counterparts.

### SUMMARY OF INVENTION

The invention provides active compound combinations which in some aspects at least achieve the stated objectives.

It has now been found that the novel active compound combination comprising 2-[α-{[(α-methyl-3-trifluoromethylbenzyl)imino]oxy}-o-tolyl]glyoxylic acid methyl ester O-methyloxime of the formula (I)

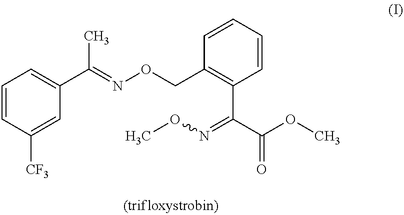

and
(2) 4,6-dimethyl-N-phenyl-2-pyrimidinamine (reference: DD 00151404) of the formula (II)

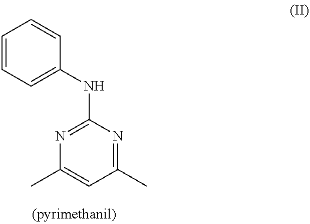

possesses very good fungicidal properties.

### DETAILED DESCRIPTION

Surprisingly, the fungicidal activity of the active compound combinations of the invention is substantially higher than the sum of the activities of the individual active compounds. In other words there is an unforeseeable, true synergistic effect and not merely a supplementation of activities.

A synergistic effect is particularly apparent when the active compounds are present in the active compound combinations according to the invention in certain weight ratios. However, the weight ratios of the active compounds in the active compound combinations can be varied within a certain range.

Preferred mixing ratios are those where trifloxystrobin and pyrimethanil are present in a ratio of from 1:1.6 to 1:7.

Furthermore preferred mixing ratios are those where trifloxystrobin and pyrimethanil are present in a ratio of from 1:2 to 1:7.

Particularly preferred mixing ratios are those where trifloxystrobin and pyrimethanil are present in a ratio of from 1:2.5 to 1:6.8.

Very particularly preferred mixing ratios are those where trifloxystrobin and pyrimethanil are present in a ratio of from 1:3 to 1:6.6.

Furthermore very particularly preferred mixing ratios are those where trifloxystrobin and pyrimethanil are present in a ratio of from 1:3 to 1:4.

Furthermore very particularly preferred mixing ratios are those where trifloxystrobin and pyrimethanil are present in a ratio of from 1:3.1 to 1:3.7.

In a very particularly preferred mixing ratio, trifloxystrobin and pyrimethanil are present in a ratio of 1:3.3.

The stated active compounds trifloxystrobin and pyrimethanil are commercially available. Information on acquisition and, where appropriate, synthesis is found in C. D. S. Tomlin, The Pesticide Manual, 13th edition, British Crop Protection Council, Farnham 2003 and the literature cited therein. The active compound of the formula (I) is known (cf., for example, EP-A-460 575).

It is evident from the structural formula of the active compound of the formula (I) that the compound may be present as E or Z isomer. Accordingly, the compound (I) may be present as a mixture of different isomers or else in the form of a single isomer. Preferred is the compound of the formula (I) in which it is present as E isomer.

The active compound combinations according to the invention have potent microbicidal activity and can be employed for controlling unwanted microorganisms, such as fungi and bacteria, in crop protection and in the protection of materials.

By way of example, fungicides can be employed in crop protection for controlling Plasmodiophoromycetes, Oomycetes, Chytridiomycetes, Zygomycetes, Ascomycetes, Basidiomycetes and Deuteromycetes.

By way of example, bactericides can be employed in crop protection for controlling Pseudomonadaceae, Rhizobiaceae, Enterobacteriaceae, Corynebacteriaceae and Streptomycetaceae.

The active compound combinations according to the invention have very good fungicidal properties and can be employed for controlling phytopathogenic fungi, such as Plasmodiophoromycetes, Oomycetes, Chytridiomycetes, Zygomycetes, Ascomycetes, Basidiomycetes, Deuteromycetes, etc.

Some pathogens causing fungal and bacterial diseases which come under the generic names listed above may be mentioned as examples, but not by way of limitation:

diseases caused by powdery mildew pathogens, such as, for example

Blumeria species such as, for example, Blumeria graminis;

Podosphaera species such as, for example, Podosphaera leucotricha;

Sphaerotheca species such as, for example, Sphaerotheca fuliginea;

Uncinula species such as, for example, Uncinula necator;

diseases caused by rust pathogens such as, for example,

Gymnosporangium species such as, for example, Gymnosporangium sabinae

Hemileia species such as, for example, Hemileia vastatrix;

Phakopsora species such as, for example, Phakopsora pachyrhizi and Phakopsora meibomiae;

Puccinia species such as, for example, Puccinia recondita;

Uromyces species such as, for example, Uromyces appendiculatus;

diseases caused by pathogens from the Oomycetene group such as, for example,

Bremia species such as, for example, Bremia lactucae;

Peronospora species such as, for example, Peronospora pisi or P. brassicae;

Phytophthora species such as, for example, Phytophthora infestans;

Plasmopara species such as, for example, Plasmopara viticola;

Pseudoperonospora species such as, for example, Pseudoperonospora humuli or Pseudoperonospora cubensis;

Pythium species such as, for example, Pythium ultimum;

leaf spot diseases and leaf wilts caused by, for example,

Alternaria species such as, for example, Alternaria solani;

Cercospora species such as, for example, Cercospora beticola;

Cladiosporum species such as, for example, Cladiosporium cucumerinum;

Cochliobolus species such as, for example, Cochliobolus sativus

(conidial form: Drechslera, syn: Helminthosporium);

Colletotrichum species such as, for example, Colletotrichum lindemuthanium;

Cycloconium species such as, for example, Cycloconium oleaginum;

Diaporthe species such as, for example, Diaporthe citri;

Elsinoe species such as, for example, Elsinoe fawcettii;

Gloeosporium species such as, for example, Gloeosporium laeticolor;

Glomerella species such as, for example, Glomerella cingulata;

Guignardia species such as, for example, Guignardia bidwelli;

Leptosphaeria species such as, for example, Leptosphaeria maculans;

Magnaporthe species such as, for example, Magnaporthe grisea;

Mycosphaerella species such as, for example, Mycosphaerella fijiensis;

Phaeosphaeria species such as, for example, Phaeosphaeria nodorum;

Pyrenophora species such as, for example, Pyrenophora teres;

Ramularia species such as, for example, Ramularia collo-cygni;

Rhynchosporium species such as, for example, Rhynchosporium secalis;

Septoria species such as, for example, Septoria apii;

Typhula species such as, for example, Typhula incarnata;

Venturia species such as, for example, Venturia inaequalis;

root and stem diseases caused by, for example,

Corticium species such as, for example, Corticium graminearum;

Fusarium species such as, for example, Fusarium oxysporum;

Gaeumannomyces species such as, for example, Gaeumannomyces graminis;

Rhizoctonia species such as, for example, Rhizoctonia solani;

Tapesia species such as, for example, Tapesia acuformis;

Thielaviopsis species such as, for example, Thielaviopsis basicola;

ear and panicle diseases (including maize cobs), caused by, for example,

Alternaria species such as, for example, Alternaria spp.;

Aspergillus species such as, for example, Aspergillus flavus;

Cladosporium species such as, for example, Cladosporium spp.;

Claviceps species such as, for example, Claviceps purpurea;

Fusarium species such as, for example, Fusarium culmorum;

Gibberella species such as, for example, Gibberella zeae;

Monographella species such as, for example, Monographella nivalis;

diseases caused by smuts such as, for example,

Sphacelotheca species such as, for example, Sphacelotheca reiliana;

Tilletia species such as, for example, Tilletia caries;

Urocystis species such as, for example, Urocystis occulta;

Ustilago species such as, for example, Ustilago nuda;

fruit rots caused by, for example,

Aspergillus species such as, for example, Aspergillus flavus;

Botrytis species such as, for example, Botrytis cinerea;

Penicillium species such as, for example, Penicillium expansum;

Sclerotinia species such as, for example, Sclerotinia sclerotiorum;

Verticilium species such as, for example, Verticilium alboatrum;

seed- and soil-borne rot and wilts, and seedling diseases, caused by, for example,

Fusarium species such as, for example, Fusarium culmorum;

Phytophthora species such as, for example, Phytophthora cactorum;

Pythium species such as, for example, Pythium ultimum;

Rhizoctonia species such as, for example, Rhizoctonia solani;

Sclerotium species such as, for example, Sclerotium rolfsii;

cankers, galls and witches' broom disease, caused by, for example,

Nectria species such as, for example, Nectria galligena;

wilts caused by, for example,

Monilinia species such as, for example, Monilinia laxa;

deformations of leaves, flowers and fruits, caused by, for example,

Taphrina species such as, for example, Taphrina deformans;

degenerative diseases of woody species, caused by, for example,

Esca species such as, for example, Phaemoniella clamydospora;

diseases of inflorescences and seeds, caused by, for example,

Botrytis species such as, for example, Botrytis cinerea;

diseases of the plant tubers, caused by, for example,

Rhizoctonia species such as, for example, Rhizoctonia solani;

diseases caused by bacterial pathogens such as, for example:

Xanthomonas species such as, for example, Xanthomonas campestris pv. oryzae;

Pseudomonas species such as, for example, Pseudomonas syringae pv. lachrymans;

Erwinia species such as, for example, Erwinia amylovora;

The following diseases of soya beans can preferably be controlled:

fungal diseases on leaves, stems, pods and seeds caused by, for example,

alternaria leaf spot (Alternaria spec. atrans tenuissima), anthracnose (Colletotrichum gloeosporoides dematium var. truncatum), brown spot (Septoria glycines), cercospora leaf spot and blight (Cercospora kikuchii), choanephora leaf blight (Choanephora infundibulifera trispora (syn.)), dactuliophora leaf spot (Dactuliophora glycines), downy mildew (Peronospora manshurica), drechslera blight (Drechslera glycini), frogeye leaf spot (Cercospora sojina), leptosphaerulina leaf spot (Leptosphaerulina trifolii), phyllostica leaf spot (Phyllosticta sojaecola), powdery mildew (Microsphaera diffusa), pyrenochaeta leaf spot (Pyrenochaeta glycines), rhizoctonia aerial, foliage, and web blight (Rhizoctonia solani), rust (Phakopsora pachyrhizi), scab (Sphaceloma glycines), stemphylium leaf blight (Stemphylium botryosum), target spot (Corynespora cassiicola)

fungal diseases on roots and the stem base caused by, for example,

black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum, Fusarium equiseti), mycoleptodiscus root rot (Mycoleptodiscus terrestris), neocosmospora (Neocosmopspora vasinfecta), pod and stem blight (Diaporthe phaseolorum), stem canker (Diaporthe phaseolorum var. caulivora), phytophthora rot (Phytophthora megasperma), brown stem rot (Phialophora gregata), pythium rot (Pythium aphanidermatum, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia southern blight (Sclerotinia rolfsii), thielaviopsis root rot (Thielaviopsis basicola).

The active compounds according to the invention also show a strong invigorating action in plants. Accordingly, they are suitable for mobilizing the internal defences of the plant against attack by unwanted microorganisms.

In the present context, plant-invigorating (resistance-inducing) compounds are to be understood as meaning substances which are capable of stimulating the defence system of plants such that, when the treated plants are subsequently inoculated with unwanted microorganisms, they display substantial resistance to these microorganisms.

In the present case, unwanted microorganisms are to be understood as meaning phytopathogenic fungi and bacteria. The compounds according to the invention can thus be used to protect plants within a certain period of time after treatment against attack by the pathogens mentioned. The period of time for which this protection is achieved generally extends for 1 to 10 days, preferably 1 to 7 days, from the treatment of the plants with the active compounds.

The active compound combinations according to the invention are particularly suitable for controlling mildew and leaf blotch diseases, fruit and blossom rots, storage diseases and secondary infections by Aspergillus/Penicillium etc.

The active compound combinations according to the invention are particularly suitable for use in viticulture, fruit cultivation, in plantation crops, in the cultivation of vegetables and in leguminous plants.

The fact that the active compound combinations are well tolerated by plants at the concentrations required for controlling plant diseases permits the treatment of above-ground parts of plants, of propagation stock and seeds, and of the soil. The active compound combinations according to the invention can be used for foliar application or else as seed dressings.

The active compound combinations according to the invention are also suitable for increasing the harvest yield. In addition, they show reduced toxicity and are well tolerated by plants.

According to the invention, it is possible to treat all plants and parts of plants. Plants are to be understood here as meaning all plants and plant populations, such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including plant cultivars which can or cannot be protected by plant breeders' certificates. Parts of plants are to be understood as meaning all above-ground and below-ground parts and organs of plants, such as shoot, leaf, flower and root, examples which may be mentioned being leaves, needles, stems, trunks, flowers, fruit-bodies, fruits and seeds and also roots, tubers and rhizomes. Parts of plants also include harvested material and vegetative and generative propagation material, for example seedlings, tubers, rhizomes, cuttings and seeds.

As already mentioned above, it is possible to treat all plants and their parts according to the invention. In a preferred embodiment, wild plant species and plant cultivars, or those obtained by conventional biological breeding, such as crossing or protoplast fusion, and parts thereof, are treated. In a further preferred embodiment, transgenic plants and plant cultivars obtained by genetic engineering, if appropriate in combination with conventional methods (Genetically Modified Organisms), and parts thereof, are treated. The term “parts” or “parts of plants” or “plant parts” has been explained above.

Particularly preferably, plants of the plant cultivars which are in each case commercially available or in use are treated according to the invention. Plant cultivars are to be understood as meaning plants having new properties (“traits”) and which have been obtained by conventional breeding, by mutagenesis or by recombinant DNA techniques. They can be cultivars, bio- and genotypes.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products are possible which exceed the effects which were actually to be expected.

The transgenic plants or plant cultivars (i.e. those obtained by genetic engineering) which are preferably to be treated according to the invention include all plants which, in the genetic modification, received genetic material which imparted particularly advantageous useful properties (“traits”) to these plants. Examples of such properties are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, cotton, oilseed rape and also fruit plants (with the fruits apples, pears, citrus fruits and grapes), and particular emphasis is given to maize, soya beans, potatoes, cotton and oilseed rape. Traits that are particularly emphasized are increased defence of the plants against insects by toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (hereinbelow referred to as “Bt plants”). Traits that are also particularly emphasized are the increased defence of the plants against fungi, bacteria and viruses by systemic acquired resistance (SAR), systemin, phytoalexins, elicitors and resistance genes and correspondingly expressed proteins and toxins. Traits that are furthermore particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combination with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucoton® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya bean), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned also include the varieties sold under the name Clearfield® (for example maize). Of course, these statements also apply to plant cultivars which have these genetic traits or genetic traits still to be developed, and which will be developed and/or marketed in the future.

The plants listed can be treated according to the invention in a particularly advantageous manner with the active compound mixtures according to the invention. The preferred ranges stated above for the active compounds or mixtures also apply to the treatment of these plants. Particular emphasis is given to the treatment of plants with the mixtures specifically mentioned in the present text.

The treatment of the plants and parts of plants according to the invention with the active compounds is carried out directly or by action on their environment, habitat or storage area according to customary treatment methods, for example by dipping, spraying, evaporating, atomizing, broadcasting, brushing-on and, in the case of propagation material, in particular in the case of seeds, furthermore by one- or multilayer coating.

The active compound combinations according to the invention can be converted into the customary formulations, such as solutions, emulsions, suspensions, powders, foams, pastes, granules, aerosols and microencapsulations in polymeric substances and in coating compositions for seeds, and also ULV formulations.

These formulations are produced in a known manner, for example by mixing the active compounds or active compound combinations with extenders, that is liquid solvents, liquefied gases under pressure, and/or solid carriers, optionally with the use of surfactants, that is emulsifiers and/or dispersants, and/or foam formers. If the extender used is water, it is also possible to employ, for example, organic solvents as auxiliary solvents. Essentially, suitable liquid solvents are: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, alcohols such as butanol or glycol and their ethers and esters, ketones such as acetone, methyl ethyl ketone, methyl isobutyl ketone or cyclohexanone, strongly polar solvents such as dimethylformamide or dimethyl sulphoxide, or else water. Liquefied gaseous extenders or carriers are to be understood as meaning liquids which are gaseous at standard temperature and under atmospheric pressure, for example aerosol propellants such as butane, propane, nitrogen and carbon dioxide. Suitable solid carriers are: for example ground natural minerals such as kaolins, clays, talc, chalk, quartz, attapulgite, montmorillonite or diatomaceous earth, and ground synthetic minerals such as finely divided silica, alumina and silicates. Suitable solid carriers for granules are: for example crushed and fractionated natural rocks such as calcite, pumice, marble, sepiolite and dolomite, or else synthetic granules of inorganic and organic meals, and granules of organic material such as sawdust, coconut shells, maize cobs and tobacco stalks. Suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates, or else protein hydrolysates. Suitable dispersants are: for example lignosulphite waste liquors and methylcellulose.

Tackifiers such as carboxymethylcellulose, natural and synthetic polymers in the form of powders, granules or latices, such as gum arabic, polyvinyl alcohol and polyvinyl acetate, or else natural phospholipids such as cephalins and lecithins and synthetic phospholipids can be used in the formulations. Other possible additives are mineral and vegetable oils.

It is possible to use colorants such as inorganic pigments, for example iron oxide, titanium oxide and Prussian Blue, and organic dyestuffs such as alizarin dyestuffs, azo dyestuffs and metal phthalocyanine dyestuffs, and trace nutrients such as salts of iron, manganese, boron, copper, cobalt, molybdenum and zinc.

The formulations generally comprise between 0.1 and 95 percent by weight of active compound, preferably between 0.5 and 90%.

The active compound combinations according to the invention can, as such or in their formulations, also be used in a mixture with known fungicides, bactericides, acaricides, nematicides or insecticides, to broaden, for example, the activity spectrum or to prevent development of resistance.

### Fungicides:

### 1. Nucleic Acid Synthesis Inhibitors

benalaxyl, benalaxyl-M, bupirimate, chiralaxyl, clozylacon, dimethirimol, ethirimol, furalaxyl, hymexazol, metalaxyl-M, ofurace, oxadixyl, oxolinic acid

### 2. Mitosis and Cell Division Inhibitors

benomyl, carbendazim, diethofencarb, fuberidazole, pencycuron, thiabendazole, thiophanate-methyl, zoxamide

### 3. Inhibitors of the Respiratory Chain

### 3.1 Complex I

diflumetorim

### 3.2 Complex II

boscalid, carboxin, fenfuram, flutolanil, furametpyr, mepronil, oxycarboxin, penthiopyrad, thifluzamide

### 3.3 Complex III

azoxystrobin, cyazofamid, dimoxystrobin, enestrobin, famoxadone, fenamidone, fluoxastrobin, kresoxim-methyl, metominostrobin, orysastrobin, pyraclostrobin, picoxystrobin

### 3.4 Decouplers

dinocap, fluazinam

### 3.5 ATP Production Inhibitors

fentin acetate, fentin chloride, fentin hydroxide, silthiofam

### 4. Amino Acid and Protein Biosynthesis Inhibitors

andoprim, blasticidin-S, cyprodinil, kasugamycin, kasugamycin hydrochloride hydrate, mepanipyrim

### 5. Signal Transduction Inhibitors

fenpiclonil, fludioxonil, quinoxyfen

### 6. Lipid and Membrane Synthesis Inhibitors

chlozolinate, iprodione, procymidone, vinclozolin

pyrazophos, edifenphos, iprobenfos (IBP), isoprothiolane

tolclofos-methyl, biphenyl

iodocarb, propamocarb, propamocarb hydrochloride

### 7. Inhibitors of Ergosterol Biosynthesis

fenhexamid,

azaconazole, bitertanol, bromuconazole, cyproconazole, diclobutrazole, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, propiconazole, prothioconazole, simeconazole, tebuconazole, tetraconazole, triadimefon, triadimenol, triticonazole, uniconazole, voriconazole, imazalil, imazalil sulphate, oxpoconazole, fenarimol, flurprimidol, nuarimol, pyrifenox, triforine, pefurazoate, prochloraz, triflumizole, viniconazole,

aldimorph, dodemorph, dodemorph acetate, fenpropimorph, tridemorph, fenpropidin, spiroxamine,

naftifine, pyributicarb, terbinafine

### 8. Cell Wall Synthesis Inhibitors

benthiavalicarb, bialaphos, dimethomorph, flumorph, iprovalicarb, polyoxins, polyoxorim, validamycin A

### 9. Melanin Biosynthesis Inhibitors

capropamid, diclocymet, fenoxanil, phthalide, pyroquilon, tricyclazole

### 10. Resistance Inductors

acibenzolar-5-methyl, probenazole, tiadinil

11. Compounds with Multisite Activity

captafol, captan, chlorothalonil, copper salts, such as: copper hydroxide, copper naphthenate, copper oxychloride, copper sulphate, copper oxide, oxine copper and Bordeaux mixture, dichlofluanid, dithianon, dodine, dodine free base, ferbam, fluorofolpet, folpet, fosetyl-Al, guazatine, guazatine acetate, iminoctadine, iminoctadine albesilate, iminoctadine triacetate, mancopper, mancozeb, maneb, metiram, metiram zinc, propineb, sulphur and sulphur preparations comprising calcium polysulphide, thiram, tolylfluanid, zineb, ziram

### 12. Unknown

amibromdol, benthiazole, bethoxazin, capsimycin, carvone, chinomethionat, chloropicrin, cufraneb, cyflufenamid, cymoxanil, dazomet, debacarb, diclomezine, dichlorophen, dicloran, difenzoquat, difenzoquat methylsulphate, diphenylamine, ethaboxam, ferimzone, flumetover, flusulfamide, fluopicolide, fluoroimide, hexachlorobenzene, 8-hydroxyquinoline sulphate, irumamycin, methasulfocarb, metrafenone, methyl isothiocyanate, mildiomycin, natamycin, nickel dimethyldithiocarbamate, nitrothal-isopropyl, octhilinone, oxamocarb, oxyfenthiin, pentachlorophenol and salts, 2-phenylphenol and salts, piperalin, propanosine-sodium, proquinazid, pyrrolnitrin, quintozene, tecloftalam, tecnazene, triazoxide, trichlamid, zarilamid and 2,3,5,6-tetrachloro-4-(methylsulphonyl)pyridine, N-(4-chloro-2-nitrophenyl)-N-ethyl-4-methylbenzenesulphonamide, 2-amino-4-methyl-N-phenyl-5-thiazolecarboxamide, 2-chloro-N-(2,3-dihydro-1,1,3-trimethyl-1H-inden-4-yl)-3-pyridinecarboxamide, 3-[5-(4-chlorophenyl)-2,3-dimethylisoxazolidin-3-yl]pyridine, cis-1-(4-chlorophenyl)-2-(1H-1,2,4-triazol-1-yl)cycloheptanol, 2,4-dihydro-5-methoxy-2-methyl-4-[[[[1-[3-(trifluoromethyl)phenyl]ethylidene]amino]oxy]methyl]phenyl]-3H-1,2,3-triazol-3-one (185336-79-2), methyl 1-(2,3-dihydro-2,2-dimethyl-1H-inden-1-yl)-1H-imidazole-5-carboxylate, 3,4,5-trichloro-2,6-pyridinedicarbonitrile, methyl 2-[[[cyclopropyl[(4-methoxyphenyl)imino]methyl]thio]methyl]-α-(methoxymethylene)benzacetate, 4-chloro-α-propynyloxy-N-[2-[3-methoxy-4-(2-propynyloxy)phenyl]ethyl]benzacetamide, (2S)—N-[2-[4-[[3-(4-chlorophenyl)-2-propynyl]oxy]-3-methoxyphenyl]ethyl]-3-methyl-2-[(methylsulphonyl)amino]butanamide, 5-chloro-7-(4-methylpiperidin-1-yl)-6-(2,4,6-trifluorophenyl)[1,2,4]triazolo[1,5-a]pyrimidine, 5-chloro-6-(2,4,6-trifluorophenyl)-N-[(1R)-1,2,2-trimethylpropyl][1,2,4]triazolo[1,5-a]pyrimidin-7-amine, 5-chloro-N-[(1R)-1,2-dimethylpropyl]-6-(2,4,6-trifluorophenyl)[1,2,4]triazolo[1,5-a]pyrimidin-7-amine, N-[1-(5-bromo-3-chloropyridin-2-yl)ethyl]-2,4-dichloronicotinamide, N-(5-bromo-3-chloropyridin-2-yl)methyl-2,4-dichloronicotinamide, 2-butoxy-6-iodo-3-propylbenzopyranon-4-one, N-{(Z)-[(cyclopropylmethoxy)imino][6-(difluoromethoxy)-2,3-difluorophenyl]methyl}-2-benzacetamide, N-(3-ethyl-3,5,5-trimethylcyclohexyl)-3-formylamino-2-hydroxybenzamide, 2-[[[[1-[3-(1-fluoro-2-phenylethyl)oxy]phenyl]ethylidene]amino]oxy]methyl]-α-(methoxyimino)-N-methyl-αE-benzacetamide, N-{2-[3-chloro-5-(trifluoromethyl)pyridin-2-yl]ethyl}-2-(trifluoromethyl)benzamide, N-(3′,4′-dichloro-5-fluorobiphenyl-2-yl)-3-(difluoromethyl)-1-methyl-1H-pyrazole-4-carboxamide, N-(6-methoxy-3-pyridinyl)cyclopropanecarboxamide, 1-[(4-methoxyphenoxy)methyl]-2,2-dimethylpropyl-1H-imidazole-1-carboxylic acid, O-[1-[(4-methoxyphenoxy)methyl]-2,2-dimethylpropyl]-1H-imidazole-1-carbothioic acid, 2-(2-{[6-(3-chloro-2-methylphenoxy)-5-fluoropyrimidin-4-yl]oxy}phenyl)-2-(methoxyimino)-N-methylacetamide

### Bactericides:

bronopol, dichlorophen, nitrapyrin, nickel dimethyldithiocarbamate, kasugamycin, octhilinone, furancarboxylic acid, oxytetracyclin, probenazole, streptomycin, tecloftalam, copper sulphate and other copper preparations.

### Insecticides/Acaricides/Nematicides:

### 1. Acetylcholinesterase (ACNE) Inhibitors

1.1 carbamates (for example alanycarb, aldicarb, aldoxycarb, allyxycarb, aminocarb, azamethiphos, bendiocarb, benfuracarb, bufencarb, butacarb, butocarboxim, butoxycarboxim, carbaryl, carbofuran, carbosulfan, chloethocarb, coumaphos, cyanofenphos, cyanophos, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, triazamate, trimethacarb, XMC, xylylcarb)

1.2 organophosphates (for example acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-5-methyl, demeton-5-methylsulphone, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion)

### 2. Sodium Channel Modulators/Blockers of Voltage-Gated Sodium Channels

2.1 pyrethroids (for example acrinathrin, allethrin (d-cis-trans, d-trans), beta-cyfluthrin, bifenthrin, bioallethrin, bioallethrin-5-cyclopentyl-isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, DDT, deltamethrin, empenthrin (1R-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (1R-isomer), tralomethrin, transfluthrin, ZXI 8901, pyrethrins (pyrethrum))

2.2 oxadiazines (for example indoxacarb)

### 3. Acetylcholine Receptor Agonists/Antagonists

3.1 chloronicotinyls/neonicotinoids (for example acetamiprid, clothianidin, dinotefuran, imidacloprid, nitenpyram, nithiazine, thiacloprid, thiamethoxam)

3.2 nicotine, bensultap, cartap

### 4. Acetylcholine Receptor Modulators

4.1 spinosyns (for example spinosad)

### 5. Antagonists of GABA-Gated Chloride Channels

5.1 cyclodiene organochlorines (for example camphechlor, chlordane, endosulfan, gamma-HCH, HCH, heptachlor, lindane, methoxychlor)

5.2 fiproles (for example acetoprole, ethiprole, fipronil, vaniliprole)

### 6. Chloride Channel Activators

6.1 mectins (for example abamectin, avermectin, emamectin, emamectin-benzoate, ivermectin, milbemectin, milbemycin)

### 7. Juvenile Hormone Mimetics

(for example diofenolan, epofenonane, fenoxycarb, hydroprene, kinoprene, methoprene, pyriproxifen, triprene)

8. Ecdyson agonists/disruptors

8.1 diacylhydrazines (for example chromafenozide, halofenozide, methoxyfenozide, tebufenozide)

### 9. Chitin Biosynthesis Inhibitors

9.1 benzoylureas (for example bistrifluoron, chlofluazuron, diflubenzuron, fluazuron, flucycloxuron, flufenoxuron, hexaflumuron, lufenuron, novaluron, noviflumuron, penfluoron, teflubenzuron, triflumuron)

9.2 buprofezin

9.3 cyromazine

### 10. Inhibitors of Oxidative Phosphorylation, ATP Disruptors

10.1 diafenthiuron

10.2 organotins (for example azocyclotin, cyhexatin, fenbutatin-oxide)

### 11. Decouplers of Oxidative Phosphorylation Acting by Interrupting the H-Proton Gradient

11.1 pyrroles (for example chlorfenapyr)

11.2 dinitrophenols (for example binapacryl, dinobuton, dinocap, DNOC)

### 12. Site-I Electron Transport Inhibitors

12.1 METIs (for example fenazaquin, fenpyroximate, pyrimidifen, pyridaben, tebufenpyrad, tolfenpyrad)

12.2 hydramethylnone

12.3 dicofol

### 13. Site-II Electron Transport Inhibitors

13.1 rotenone

### 14. Site-III Electron Transport Inhibitors

14.1 acequinocyl, fluacrypyrim

### 15. Microbial Disruptors of the Insect Gut Membrane

Bacillus thuringiensis strains

### 16. Inhibitors of Fat Synthesis

16.1 tetronic acids (for example spirodiclofen, spiromesifen)

16.2 tetramic acids [for example 3-(2,5-dimethylphenyl)-8-methoxy-2-oxo-1-azaspiro[4.5]dec-3-en-4-yl ethyl carbonate (alias: carbonic acid, 3-(2,5-dimethylphenyl)-8-methoxy-2-oxo-1-azaspiro[4.5]dec-3-en-4-yl ethyl ester, CAS Reg. No.: 382608-10-8) and carbonic acid, cis-3-(2,5-dimethylphenyl)-8-methoxy-2-oxo-1-azaspiro[4.5]dec-3-en-4-yl ethyl ester (CAS Reg. No.: 203313-25-1)]

### 17. Carboxamides

(for example flonicamid)

### 18. Octopaminergic Agonists

(for example amitraz)

### 19. Inhibitors of Magnesium-Stimulated ATPase

(for example propargite)

### 20. Phthalamides

(for example N²-[1,1-dimethyl-2-(methylsulphonyl)ethyl]-3-iodo-N¹-[2-methyl-4-[1,2,2,2-tetrafluoro-1-(trifluoromethyl)ethyl]phenyl]-1,2-benzenedicarboxamide (CAS Reg. No.: 272451-65-7), flubendiamide)

### 21. Nereistoxin Analogues

(for example thiocyclam hydrogen oxalate, thiosultap-sodium)

### 22. Biologicals, Hormones or Pheromones

(for example azadirachtin, Bacillus spec., Beauveria spec., Codlemone, Metarrhizium spec., Paecilomyces spec., Thuringiensin, Verticillium spec.)

23. Active Compounds with Unknown or Unspecific Mechanisms of Action

23.1 fumigants (for example aluminium phosphide, methyl bromide, sulphuryl fluoride)

23.2 selective antifeedants (for example cryolite, flonicamid, pymetrozine)

23.3 mite growth inhibitors (for example clofentezine, etoxazole, hexythiazox)

23.4 amidoflumet, benclothiaz, benzoximate, bifenazate, bromopropylate, buprofezin, chinomethionat, chlordimeform, chlorobenzilate, chloropicrin, clothiazoben, cycloprene, cyflumetofen, dicyclanil, fenoxacrim, fentrifanil, flubenzimine, flufenerim, flutenzin, gossyplure, hydramethylnone, japonilure, metoxadiazone, petroleum, piperonyl butoxide, potassium oleate, pyrafluprole, pyridalyl, pyriprole, sulfluramid, tetradifon, tetrasul, triarathene, verbutin,

furthermore the compound 3-methylphenyl propylcarbamate (Tsumacide Z), the compound 3-(5-chloro-3-pyridinyl)-8-(2,2,2-trifluoroethyl)-8-azabicyclo[3.2.1]octane-3-carbonitrile (CAS Reg. No. 185982-80-3) and the corresponding 3-endo-isomer (CAS Reg. No. 185984-60-5) (cf. WO 96/37494, WO 98/25923), and preparations which comprise insecticidally active plant extracts, nematodes, fungi or viruses.

A mixture with other known active compounds, such as herbicides, safeners and/or semiochemicals, or with fertilizers and growth regulators is also possible.

The compounds (I) and (II) can be applied simultaneously, and, if so, either together or separately, or in succession; in the case of separate application, the sequence generally has no consequence for the control outcome.

The active compound combinations can be used as such, in the form of their formulations or the use forms prepared therefrom, such as ready-to-use solutions, emulsifiable concentrates, emulsions, suspensions, wettable powders, soluble powders and granules. Application is carried out in a customary manner, for example by watering, spraying, atomizing, broadcasting, dusting, dry dressing, moistened dressing, wet dressing, slurry dressing or encrusting.

When using the active compound combinations according to the invention, the application rates can be varied within a relatively wide range, depending on the kind of application. For the treatment of parts of plants, the active compound combination application rates are generally between 0.1 and 10 000 g/ha, preferably between 10 and 1000 g/ha. For seed dressing, the active compound combination application rates are generally between 0.001 and 50 g per kilogram of seed, preferably between 0.01 and 10 g per kilogram of seed. For the treatment of the soil, the active compound combination application rates are generally between 0.1 and 10 000 g/ha, preferably between 1 and 5000 g/ha.

The good fungicidal activity of the active compound combinations according to the invention is demonstrated by the examples below. Whereas the individual active compounds exhibit weaknesses in fungicidal activity, the combinations display an activity which goes beyond a simple summation of activities.

A synergistic effect is always present in fungicides when the fungicidal activity of the active compound combinations is greater than the sum of the activities of the active compounds applied individually.

The expected activity for a given combination of two active compounds can be calculated in accordance with S. R. Colby (“Calculating Synergistic and Antagonistic Responses of Herbicide Combinations”, Weeds 15 (1967), 20-22) as follows:

### If

X denotes the efficacy when using active compound A at an application rate of m g/ha,
Y denotes the efficacy when using active compound B at an application rate of n g/ha, and
E denotes the efficacy when using active compounds A and B at application rates of m and n g/ha,
   then

$$E = X + Y - \frac{X \cdot Y}{100}$$

The efficacy here is determined in %. 0% denotes an efficacy which corresponds to that of the control, while an efficacy of 100% means that no infestation is observed.

If the actual fungicidal activity is greater than that calculated, then the activity of the combination is superadditive: in other words, a synergistic effect is obtained. In this case the efficacy actually observed must be greater than the value calculated using the above-indicated formula for the expected efficacy (E).

Another method of determining synergistic effects is offered by the Tammes model (Neth. J. Plant Path. 70 (1964) 73-80), where, for example, the theoretical dosage for an efficacy of 90% is determined and is compared with the dosage actually required.

The invention is illustrated by the following examples. The invention is not, however, limited to the examples.

### Example

### Sphaerotheca Test (Cucumber)

### Protective

Solvents: 24.5 parts by weight of acetone
24.5 parts by weight of dimethylacetamide

Emulsifier: 1 part by weight of alkylaryl polyglycol ether

To produce a suitable preparation of active compound, 1 part by weight of active compound or active compound combination is mixed with the stated amounts of solvents and emulsifier, and the concentrate is diluted with water to the desired concentration, or a commercial formulation of active compound or active compound combination with water is diluted with water to the desired concentration.

To test for protective activity, young plants are sprayed with the active compound preparation at the stated application rate. After the spray coating has dried on, the plants are inoculated with an aqueous spore suspension of Sphaerotheca fuliginea. The plants are then placed in a greenhouse at about 23° C. and a relative atmospheric humidity of about 70%.

Evaluation is carried out 7 days after inoculation. Here, 0% means an efficacy which corresponds to that of the control, whereas an efficacy of 100% means that no infestation is observed.

The invention is illustrated by the following examples.

The table below shows clearly that the activity found for the active compound combination according to the invention is greater than the calculated activity, i.e. a synergistic effect is present. The synergism found is surprisingly clearly pronounced for the mixing ratios according to the invention, the mixing ratio (I) to (II) of 1:3.3 having the most pronounced synergistic effect.

TABLE
Sphaerotheca test (cucumber)/protective

| | Active | |
|---|---|---|
| | compound | |
| | application | |
| Active compound Known: | rate in ppm | % efficacy |
| 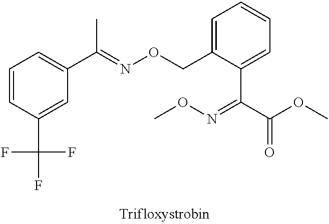 | 4 | 10 |
| 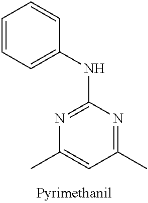 | 3.3 6.6 13.2 26.4 52.8 | 0 0 0 0 0 |

Mixture according to the invention:

| | | | | | | Expected |
|---|---|---|---|---|---|---|
| | | | | | | value |
| | | | Active | | | calculated |
| | | | compound | | | using |
| | | Mixing | application | | Actual | Colby's |
| | | ratio | rate in ppm | | efficacy | formula |
| Trifloxystrobin + | | | | | | |
| | {close oversize brace} | 1:0.83 | 4 + 3.3 | {close oversize brace} | 53 | 10 |
| Pyrimethanil | | | | | | |
| Trifloxystrobin + | | | | | | |
| | {close oversize brace} | 1:1.65 | 4 + 6.6 | {close oversize brace} | 57 | 10 |
| Pyrimethanil | | | | | | |
| Trifloxystrobin + | | | | | | |
| | {close oversize brace} | 1:3.3 | 4 + 13.2 | {close oversize brace} | 73 | 10 |
| Pyrimethanil | | | | | | |
| Trifloxystrobin + | | | | | | |
| | {close oversize brace} | 1:6.6 | 4 + 26.4 | {close oversize brace} | 65 | 10 |
| Pyrimethanil | | | | | | |
| Trifloxystrobin + | | | | | | |
| | {close oversize brace} | 1:13.2 | 4 + 52.8 | {close oversize brace} | 57 | 10 |
| Pyrimethanil | | | | | | |

The test demonstrated synergism between trifloxystrobin and pyrimethanil.

1. A method for controlling phytopathogenic fungi, comprising allowing an active compound combination to act on fungi, a habitat of fungi, a plant, a plant part, a seed, soil, and/or any area, material or space to be kept free from fungi; the active compound combination comprising:
a compound of formula (I) 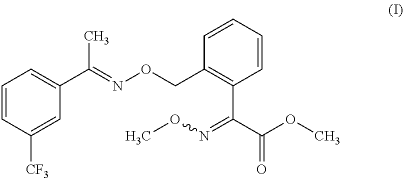
and
a compound of formula (II)

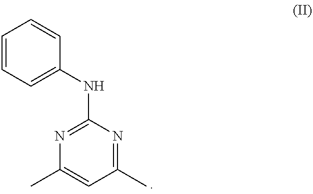

2. A method according to claim 1, wherein the compound of formula (I) and the compound of formula (II) are applied simultaneously.

3. A method according to claim 1, wherein the compound of formula (I) and the compound of formula (II) are applied separately.

4. A method according to claim 1, wherein the weight ratio of formula (I) to formula (II) is from 1:0.83 to 1:13.2.

5. A method according to claim 1, wherein the weight ratio of formula (I) to formula (II) is from 1:1.6 to 1:7.

6. A method according to claim 1, wherein the weight ratio of formula (I) to formula (II) is from 1:2.5 to 1:7.

7. A method according to claim 1, wherein the weight ratio of formula (I) to formula (II) is from 1:2.5 to 1:6.8.

8. A method according to claim 1, wherein the weight ratio of formula (I) to formula (II) is from 1:3 to 1:4.

9. A method according to claim 1, wherein the weight ratio of formula (I) to formula (II) is from 1:3.1 to 1:3.7.

10. A method according to claim 1, wherein the weight ratio of formula (I) to formula (II) is about 1:3.3.

11. A method according to claim 1, wherein the weight ratio of formula (I) to formula (II) is about 1:7.

12. A method according to claim 1, wherein the compound of formula (I) and the compound of formula (II) are mixed with an extender and/or a surfactant.

13. A method according to claim 1, wherein the controlled phytopathogenic fungi are selected from the group consisting of Oomycetes, Zygomycetes, Ascomycetes, Basidiomycetes, and Deuteromycetes.

14. A method according to claim 1, wherein the seed is treated with the active compound combination.

15. A method according to claim 1, wherein the plant is treated with the active compound combination.

16. A method according to claim 15, wherein the plant is a fruit plant.

17. A method according to claim 1, wherein the active compound combination is sprayed on the fungi, the habitat of the fungi, the plant, the plant part, the seed, the soil, and/or any area, material or space to be kept free from the fungi.

18. A method for controlling phytopathogenic fungi, comprising allowing an active compound mixture to act on fungi, a habitat of fungi, a plant, a plant part, a seed, soil, and/or any area, material or space to be kept free from fungi; the active compound mixture comprising:
a compound of formula (I) 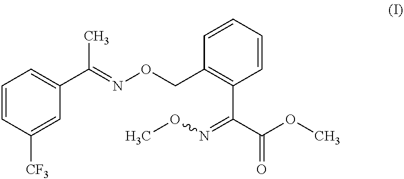
and
a compound of formula (II)

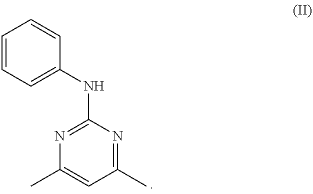

19. A method according to claim 18, wherein the weight ratio of formula (I) to formula (II) is from 1:0.83 to 1:13.2.

20. A method for controlling fungi, comprising allowing an active compound combination to act on fungi, a habitat of fungi, a plant, a plant part, a seed, soil, and/or any area, material or space to be kept free from fungi; the active compound combination comprising:
a compound of formula (I) 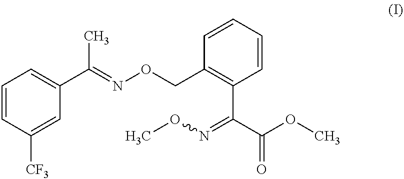
and
a compound of formula (II)

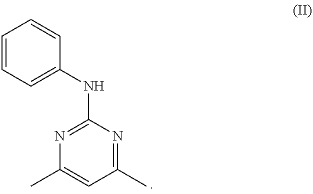

21. A method according to claim 20, wherein the weight ratio of formula (I) to formula (II) is from 1:0.83 to 1:13.2.
